(19) United States
(12) Patent Application Publication
(10) Pub. No.: US 2026/0138095 A1
(43) Pub. Date: May 21, 2026

(54) ORGANOSILICA MEMBRANE WITH POROUS INTERMEDIATE LAYER AND METHOD FOR PREPARING THE SAME

(71) Applicant: CHANGZHOU UNIVERSITY, Changzhou (CN)

(72) Inventors: Xiuxiu REN, Changzhou (CN); Jing ZHONG, Changzhou (CN); Meng GUO, Changzhou (CN); Dongliang JIN, Changzhou (CN); Ting QI, Changzhou (CN); Yang PAN, Changzhou (CN); Yuanliang GU, Changzhou (CN)

(73) Assignee: CHANGZHOU UNIVERSITY, Changzhou (CN)

(21) Appl. No.: 19/452,857

(22) Filed: Jan. 19, 2026

Related U.S. Application Data
(63) Continuation of application No. PCT/CN2025/130390, filed on Oct. 28, 2025.

(30) Foreign Application Priority Data
Oct. 28, 2024 (CN) 202411507888.8

(51) Int. Cl. B01D 67/00; B01D 61/36; B01D 69/10; B01D 71/02; B01D 71/70; C01B 32/174; C02F 1/44

(52) U.S. Cl. CPC B01D 67/0079; B01D 61/362; B01D 69/105; B01D 69/108; B01D 71/0212; B01D 71/70; C01B 32/174; C02F 1/448

(57) ABSTRACT

The present disclosure relates to an organosilica membrane with a porous intermediate layer and a method for preparing the same. The method includes: treating carbon nanotubes with an acid, washing, and drying to obtain carboxylated carbon nanotubes (COOH-CNTs); adding water to the COOH-CNTs and a SiO₂—ZrO₂ sol, and mixing uniformly to obtain a COOH-CNTs/SiO₂—ZrO₂ sol; coating the COOH-CNTs/SiO₂—ZrO₂ sol onto a tubular ceramic support, and calcining to obtain a ceramic support with a porous intermediate layer; and coating an organosilica sol onto the ceramic support with the porous intermediate layer, and performing a heat treatment to form a separation layer, thereby obtaining the organosilica membrane.

### CROSS-REFERENCE TO RELATED APPLICATIONS

This application is a Continuation of International Application No. PCT/CN2025/130390, filed on Oct. 28, 2025, which claims priority to Chinese Patent Application No. 202411507888.8, filed on Oct. 28, 2024, the entire contents of each of which are hereby incorporated by reference.

### TECHNICAL FIELD

The present disclosure generally relates to a field of membrane separation technology, and in particular to an organosilica membrane with a porous intermediate layer and a method for preparing the same.

### BACKGROUND

Pervaporation membranes for solvent or water separation are in high industrial demand. For the dehydration of acidic organic compounds, such as acetic acid dehydration or for the dehydration of organic solvents under acidic conditions, the pervaporation technology imposes stringent requirements on the acid resistance of the membranes.

An organosilica membrane exhibits superior stability in acidic and hydrothermal environments compared to polymeric membranes and inorganic membranes. The organosilica membrane generally has a multi-layer asymmetric structure composed of a support and a separation layer. The support mainly provides sufficient mechanical strength, and the separation layer mainly serves the sieving function. A ceramic support, characterized by a relatively large pore size and a relatively rough surface, requires the introduction of an intermediate layer to reduce both the pore size and surface roughness. However, conventional processes for preparing such intermediate layer are complex. They usually include depositing structurally similar materials (e.g., silica sol or alumina sol particles) onto the support, and performing multiple coatings to narrow the pores between stacked particles, which results in an intermediate layer with low porosity and a long mass transfer pathway, leading to a reduction in permeation flux of the membrane in pervaporation.

Currently, the organosilica membrane is generally prepared by the wipe-coating manner or the dip-coating manner (Waseem Raza, et al. HCl modification and pervaporation performance of BTESE membrane for the dehydration of acetic acid/water mixture[J]. Separation and Purification Technology, 2020, 235: 116102; Hessel L. Castricum, et al. High-performance hybrid pervaporation membranes with superior hydrothermal and acid stability[J]. Journal of Membrane Science, 2008, 324: 111-118). The wipe-coating manner generally results in low reproducibility of the prepared membrane and is prone to defects of incomplete coverage, while membranes formed by the dip-coating manner tend to be thicker and are prone to cracking, which leads to a low separation factor in pervaporation.

Therefore, it is necessary to provide an organosilica membrane with a porous intermediate layer and a method for preparing the same.

### SUMMARY

One or more embodiments of the present disclosure provide a method for preparing an organosilica membrane with a porous intermediate layer, including the following steps: (1) treating carbon nanotubes with an acid, washing, and drying to obtain carboxylated carbon nanotubes (COOH-CNTs); (2) adding water to the COOH-CNTs obtained in step (1) and a SiO₂—ZrO₂ sol, and mixing uniformly to obtain a COOH-CNTs/SiO₂—ZrO₂ sol; (3) coating the COOH-CNTs/SiO₂—ZrO₂ sol obtained in step (2) onto a tubular ceramic support, and calcining to obtain a ceramic support with a porous intermediate layer; and (4) coating an organosilica sol onto the ceramic support with the porous intermediate layer obtained in step (3), and performing heat treatment to form a separation layer, thereby obtaining the organosilica membrane; wherein the organosilica sol is prepared by a hydrolytic polymerization reaction of an organosilica precursor selected from organoalkoxysilanes such as 1,2-bis(triethoxysilyl)ethane (BTESE) or bis(triethoxysilyl)methane (BTESM).

In some embodiments, in step (1), the acid is a mixture of concentrated sulfuric acid and concentrated nitric acid, wherein a volume ratio of the concentrated sulfuric acid to the concentrated nitric acid is 3:1; a temperature of the treating is in a range of 60° C.-100° C., and a time of the treating is in a range of 2 h-4 h.

In some embodiments, in step (1), the washing is alternately washing with deionized water and ethanol until carbon nanotubes after the treating reach a neutral pH.

In some embodiments, in step (1), a temperature of the drying is in a range of 50° C.-80° C., and a time of the drying is in a range of 12 h-24 h.

In some embodiments, in step (1), a process for preparing the COOH-CNTs includes: placing the carbon nanotubes in the mixture of the concentrated sulfuric acid (98 wt %) and the concentrated nitric acid (68 wt %), treating at 100° C. for 4 h, alternately washing with the deionized water and the ethanol until the carbon nanotubes after the treating reach the neutral pH, and drying to obtain the COOH-CNTs.

In some embodiments, in step (2), a mass ratio of the COOH-CNTs to SiO₂—ZrO₂ is in a range of 1%-7%.

In the present disclosure, the SiO₂—ZrO₂ sol is prepared by referring to a preparation process of CN113058447A.

According to a molar ratio of tetraethyl orthosilicate, zirconium n-butoxide, ethanol, and hydrochloric acid of 1:5:10:2, a stable SiO₂—ZrO₂ sol is prepared by mixing these four substances together to obtain a mixture, adjusting a water content of the mixture to maintain a sum of mass fractions of the tetraethyl orthosilicate and the zirconium n-butoxide at 2 wt % to obtain a solution, heating the solution to 100° C. and maintaining boiling for 6 h.

In some embodiments, wherein, in step (3), the coating is spin coating, wherein the spin coating includes fixing the tubular ceramic support on an iron rod and rotating the tubular ceramic support, placing the COOH-CNTs/SiO₂—ZrO₂ sol below the tubular ceramic support, loading the COOH-CNTs/SiO₂—ZrO₂ sol onto the tubular ceramic support at a low speed, and performing spin drying of the COOH-CNTs/SiO₂—ZrO₂ sol at a high speed; wherein the low speed has a rotation speed of 10 rpm-100 rpm, and the high speed has a rotation speed of 600 rpm-6000 rpm, maintained for 30 s-60 s.

In some embodiments, in step (3), preheating is performed before the calcining, wherein a temperature of the preheating is in a range of 100° C.-200° C., and a time of the preheating is in a range of 5 min-10 min.

In some embodiments, in step (3), a temperature of the calcining is in a range of 450° C.-550° C., a time of the calcining is in a range of 20 min-60 min, and a count of repetitions of the coating and the calcining is in a range of 2-6 times.

In some embodiments, in step (4), the organosilica sol is prepared by a hydrolytic polymerization reaction of the organosilica precursor catalyzed by an acidic catalyst.

In some embodiments, the organosilica precursor may be BTESE or BTESM.

In some embodiments, the organosilica precursor is BTESE.

In some embodiments, the acidic catalyst may be hydrochloric acid, sulfuric acid, or nitric acid.

In some embodiments, the acidic catalyst is hydrochloric acid.

In some embodiments, in step (4), the coating is spin coating.

In some embodiments, the spin coating includes coating the organosilica sol onto the ceramic support with the porous intermediate layer at a low rotation speed of 20 rpm, and then increasing the rotation speed to 1000 rpm and maintaining for 30 s.

In some embodiments, in step (4), the heat treatment is calcining in an air atmosphere at a temperature in a range of 100° C.-250° C. for a time in a range of 30 min-60 min.

One or more embodiments of the present disclosure provide the organosilica membrane with the porous intermediate layer prepared by the method.

One or more embodiments of the present disclosure provide a method for performing pervaporation using the organosilica membrane with the porous intermediate layer. The method includes placing the organosilica membrane with the porous intermediate layer into a membrane module and performing the pervaporation to separate a solvent or an aqueous solution.

One or more embodiments of the present disclosure also provide a use of the organosilica membrane with the porous intermediate layer in pervaporation.

The use includes placing the organosilica membrane with the porous intermediate layer into the membrane module and performing the pervaporation to separate a solvent or an aqueous solution.

One or more embodiments of the present disclosure also provide a manner for dehydration of an acidic system by pervaporation. The manner includes performing pervaporation of an acetic acid aqueous solution with a mass fraction of 90 wt % using the organosilica membrane with the porous intermediate layer. A heating temperature of the acetic acid aqueous solution is 75° C., and a permeate side is evacuated (e.g., a pressure of the permeate side is less than 400 Pa).

### BRIEF DESCRIPTION OF THE DRAWINGS

FIG. 1 is an SEM image of an organosilica membrane prepared in Example 1.

FIG. 2 is an SEM image of an organosilica membrane prepared in Comparative Example 1.

FIG. 3 is a schematic diagram of water molecules passing through an intermediate layer of the organosilica membrane.

### DETAILED DESCRIPTION

The technical solution of the present disclosure is described in detail below through specific embodiments. However, the protection scope of the present disclosure is not limited to the described embodiments.

For those not specifying specific techniques or conditions in the embodiments, the techniques or conditions described in the literature in the field or the product instructions are followed. Reagents or instruments used without indicating the manufacturer are conventional products that can be purchased through regular channels.

An intermediate layer of an existing organosilica membrane typically uses materials with a structure similar to a separation layer and is prepared by multiple wipe-coating or dip-coating, resulting in a low flux of the obtained organosilica membrane. Coating times are reduced and a water permeation flux and a separation factor of a prepared organosilica membrane with a porous intermediate layer are improved by doping COOH-CNTs into a SiO₂—ZrO₂ sol and coating a COOH-CNTs/SiO₂—ZrO₂ sol onto a tubular ceramic support by spin coating in some embodiments of the present disclosure.

Embodiments of the present disclosure provide a method for preparing the organosilica membrane with the porous intermediate layer. The method includes the following steps.

Step (1), treating carbon nanotubes with an acid, washing, and drying to obtain carboxylated carbon nanotubes (COOH-CNTs).

The carbon nanotubes may include single-walled carbon nanotubes or multi-walled carbon nanotubes. In some embodiments, a length of the carbon nanotubes is in a range of 100 nm-2000 nm. In some embodiments, a diameter of the carbon nanotubes is in a range of 8 nm-12 nm.

The acid is a mixture of concentrated sulfuric acid and concentrated nitric acid. In some embodiments, a volume ratio of the concentrated sulfuric acid to the concentrated nitric acid in the mixture is in a range of (1-3):1. For example, a volume ratio of the concentrated sulfuric acid to the concentrated nitric acid in the mixture is 3:1.

A mass fraction of the concentrated sulfuric acid may be in a range of 95%-98%. Merely by way of example, the mass fraction of the concentrated sulfuric acid is 98%.

A mass fraction of the concentrated nitric acid may be in a range of 65%-68%. Merely by way of example, the mass fraction of the concentrated nitric acid is 68%.

In some embodiments, a temperature of the treating the carbon nanotubes with the acid is in a range of 60° C.-100° C. In some embodiments, the temperature of the treating the carbon nanotubes with the acid is in a range of 70° C.-100° C. In some embodiments, the temperature of the treating the carbon nanotubes with the acid is in a range of 80° C.-100° C. In some embodiments, the temperature of the treating the carbon nanotubes with the acid is in a range of 90° C.-100° C. In some embodiments, the temperature of the treating the carbon nanotubes with the acid is 60° C., 70° C., 80° C., 90° C., 100° C., etc.

In some embodiments, a time of the treating the carbon nanotubes with the acid is in a range of 2 h-4 h. In some embodiments, the time of the treating the carbon nanotubes with the acid is in a range of 3 h-4 h. In some embodiments, the time of the treating the carbon nanotubes with the acid is 2 h, 2.5 h, 3 h, 3.5 h, 4 h, etc.

In some embodiments, in step (1), the washing is alternately washing with deionized water and ethanol until carbon nanotubes after the treating reach a neutral pH. The neutral pH refers to a pH of approximately 7. Merely by way of example, the washing may include first washing with the deionized water, then washing with the ethanol, and then repeating the aforementioned washing process.

In some embodiments, in step (1), a temperature of the drying is in a range of 50° C.-80° C. In some embodiments, in step (1), a time of the drying is in a range of 12 h-24 h.

The COOH-CNTs refer to modified carbon nanotubes in which carboxyl functional groups are covalently bonded to surfaces of the carbon nanotubes through a chemical manner.

In some embodiments, in step (1), a process for preparing the COOH-CNTs includes placing the carbon nanotubes in the mixture of the concentrated sulfuric acid (98 wt %) and the concentrated nitric acid (68 wt %), treating at 100° C. for 4 h, alternately washing with the deionized water and the ethanol until the carbon nanotubes after the treating reach the neutral pH, and drying to obtain the COOH-CNTs.

Step (2), adding water to the COOH-CNTs obtained in step (1) and a SiO₂—ZrO₂ sol, and mixing uniformly to obtain a COOH-CNTs/SiO₂—ZrO₂ sol.

The SiO₂—ZrO₂ sol used in the embodiments and comparative examples of the present disclosure is prepared by referring to a preparation process of CN113058447A.

According to a molar ratio of tetraethyl orthosilicate, zirconium n-butoxide, ethanol, and hydrochloric acid of 1:5:10:2, a stable SiO₂—ZrO₂ sol is prepared by mixing these four substances together to obtain a mixture, adjusting a water content of the mixture to maintain a sum of mass fractions of the tetraethyl orthosilicate and the zirconium n-butoxide at 2 wt % to obtain a solution, heating the solution to 100° C. and maintaining boiling for 6 h.

In some embodiments, the amount of the water added is such that a mass fraction of SiO₂—ZrO₂ in a solution formed by the COOH-CNTs, the SiO₂—ZrO₂ sol, and the water is in a range of 0.5 wt %-1 wt %.

In some embodiments, in step (2), a mass ratio of the COOH-CNTs to SiO₂—ZrO₂ is in a range of 1%-7%. In some embodiments, in step (2), the mass ratio of the COOH-CNTs to the SiO₂—ZrO₂ is in a range of 2%-7%. In some embodiments, in step (2), the mass ratio of the COOH-CNTs to the SiO₂—ZrO₂ is in a range of 3%-7%. In some embodiments, in step (2), the mass ratio of the COOH-CNTs to the SiO₂—ZrO₂ is in a range of 4%-7%. In some embodiments, in step (2), the mass ratio of the COOH-CNTs to the SiO₂—ZrO₂ is in a range of 5%-7%. In some embodiments, in step (2), the mass ratio of the COOH-CNTs to the SiO₂—ZrO₂ is in a range of 6%-7%. In some embodiments, in step (2), the mass ratio of the COOH-CNTs to the SiO₂—ZrO₂ is in a range of 2%-6%. In some embodiments, in step (2), the mass ratio of the COOH-CNTs to the SiO₂—ZrO₂ is in a range of 3%-5%. In some embodiments, in step (2), the mass ratio of the COOH-CNTs to the SiO₂—ZrO₂ is in a range of 4%-5%. In some embodiments, in step (2), the mass ratio of the COOH-CNTs to the SiO₂—ZrO₂ is 1%, 2%, 3%, 4%, 5%, 6%, 7%, etc.

The COOH-CNTs/SiO₂—ZrO₂ sol refers to a mixed colloidal solution formed by uniformly dispersing the COOH-CNTs in the SiO₂—ZrO₂ sol and is used for preparing the porous intermediate layer.

Step (3), coating the COOH-CNTs/SiO₂—ZrO₂ sol obtained in step (2) onto a tubular ceramic support, and calcining to obtain a ceramic support with the porous intermediate layer.

The tubular ceramic support refers to a porous ceramic substrate with a hollow cylindrical structure and a certain mechanical strength and a certain porosity, and is used for carrying an intermediate layer and a separation layer. The tubular ceramic support serves as a structural skeleton of the organosilica membrane.

In some embodiments, in step (3), the coating is spin coating. The spin coating includes fixing the tubular ceramic support on an iron rod and rotating the tubular ceramic support, placing the COOH-CNTs/SiO₂—ZrO₂ sol below the tubular ceramic support, loading the COOH-CNTs/SiO₂—ZrO₂ sol onto the tubular ceramic support at a low speed, and performing spin drying of the COOH-CNTs/SiO₂—ZrO₂ sol at a high speed.

In some embodiments, the low speed has a rotation speed of 10 rpm-100 rpm. In some embodiments, the low speed has a rotation speed of 20 rpm-90 rpm. In some embodiments, the low speed has a rotation speed of 30 rpm-80 rpm. In some embodiments, the low speed has a rotation speed of 40 rpm-70 rpm. In some embodiments, the low speed has a rotation speed of 50 rpm-60 rpm. In some embodiments, the low speed has a rotation speed of 10 rpm, 20 rpm, 30 rpm, 40 rpm, 50 rpm, 60 rpm, 70 rpm, 80 rpm, 90 rpm, 100 rpm, etc.

In some embodiments, the high speed has a rotation speed of 600 rpm-6000 rpm. In some embodiments, the high speed has a rotation speed of 800 rpm-5000 rpm. In some embodiments, the high speed has a rotation speed of 1000 rpm-4000 rpm. In some embodiments, the high speed has a rotation speed of 1500 rpm-3500 rpm. In some embodiments, the high speed has a rotation speed of 2000 rpm-3000 rpm. In some embodiments, the high speed has a rotation speed of 2000 rpm-2500 rpm. In some embodiments, the high speed has a rotation speed of 600 rpm, 1000 rpm, 2000 rpm, 3000 rpm, 4000 rpm, 5000 rpm, 6000 rpm, etc.

In some embodiments, the high speed rotation is maintained for 30 s-60 s. In some embodiments, the high speed rotation is maintained for 40 s-60 s. In some embodiments, the high speed rotation is maintained for 50 s-60 s. In some embodiments, the high speed rotation is maintained for 30 s, 40 s, 50 s, 60 s, etc.

In some embodiments, in step (3), preheating is performed on the tubular ceramic support coated with the COOH-CNTs/SiO₂—ZrO₂ sol before the calcining.

In some embodiments, a temperature of the preheating is in a range of 100° C.-200 ° C. In some embodiments, the temperature of the preheating is in a range of 120° C.-200 ° C. In some embodiments, the temperature of the preheating is in a range of 140° C.-200 ° C. In some embodiments, the temperature of the preheating is in a range of 160° C.-200 ° C. In some embodiments, the temperature of the preheating is in a range of 180° C.-200 ° C. In some embodiments, the temperature of the preheating is 100° C., 130° C., 150° C., 180° C., 200° C., etc.

In some embodiments, a time of the preheating is in a range of 5 min-10 min. In some embodiments, the time of the preheating is in a range of 6 min-9 min. In some embodiments, the time of the preheating is in a range of 7 min-8 min. In some embodiments, the time of the preheating is 5 min, 6 min, 7 min, 8 min, 9 min, 10 min, etc.

In some embodiments, in step (3), a temperature of the calcining is in a range of 450° C.-550° C. In some embodiments, the temperature of the calcining is in a range of 480° C.-550 ° C. In some embodiments, the temperature of the calcining is in a range of 500° C.-550 ° C. In some embodiments, the temperature of the calcining is in a range of 520° C.-550 ° C. In some embodiments, the temperature of the calcining is in a range of 450° C.-500 ° C. In some embodiments, the temperature of the calcining is in a range of 450° C.-480 ° C. In some embodiments, the temperature of the calcining is 450° C., 480° C., 500° C., 520° C., 550° C., etc.

In some embodiments, a time of the calcining is in a range of 20 min-60 min. In some embodiments, the time of the calcining is in a range of 30 min-60 min. In some embodiments, the time of the calcining is in a range of 40 min-50 min. In some embodiments, the time of the calcining is 20 min, 30 min, 40 min, 50 min, 60 min, etc.

In some embodiments, in step (3), the coating and the calcining are repeated. In some embodiments, a count of repetitions of the coating and the calcining is in a range of 2-6 times. In some embodiments, the count of repetitions of the coating and the calcining is in a range of 3-6 times. In some embodiments, the count of repetitions of the coating and the calcining is in a range of 4-5 times. In some embodiments, the count of repetitions of the coating and the calcining is 2 times, 3 times, 4 times, 5 times, 6 times, etc.

The ceramic support with the porous intermediate layer refers to an intermediate product formed by coating and calcining the COOH-CNTs/SiO₂—ZrO₂ sol on the tubular ceramic support.

Step (4), coating an organosilica sol onto the ceramic support with the porous intermediate layer obtained in step (3), and performing heat treatment to form a separation layer, thereby obtaining the organosilica membrane.

The organosilica sol refers to a colloidal solution used to form the separation layer on the ceramic support with the porous intermediate layer.

In some embodiments, in step (4), the organosilica sol is prepared by a hydrolytic polymerization reaction of an organosilica precursor catalyzed by an acidic catalyst.

The organosilica precursor refers to a core reactant used to synthesize the organosilica sol. The organosilica precursor may be BTESE or BTESM.

In some embodiments, the acidic catalyst may be hydrochloric acid, sulfuric acid, or nitric acid. For example, the acidic catalyst is the hydrochloric acid.

In some embodiments, the organosilica sol is prepared by the hydrolytic polymerization reaction of the organosilica precursor selected from BTESE or BTESM.

In some embodiments, in step (4), the coating is spin coating.

In some embodiments, the spin coating includes coating the organosilica sol onto the ceramic support with the porous intermediate layer at a low rotation speed of 20 rpm, and then increasing the rotation speed to 1000 rpm and maintaining for 30 s.

In some embodiments, in step (4), the heat treatment is calcining in an air atmosphere at a temperature in a range of 100° C.-250° C. for a time in a range of 30 min-60 min.

In some embodiments, the temperature of the calcining of the heat treatment is in a range of 100° C.-250° C. In some embodiments, the temperature of the calcining of the heat treatment is in a range of 150° C.-250° C. In some embodiments, the temperature of the calcining of the heat treatment is in a range of 200° C.-250° C. In some embodiments, the temperature of the calcining of the heat treatment is 100° C., 150° C., 200° C., 250° C., etc.

In some embodiments, the time of the calcining of the heat treatment is in a range of 30 min-60 min. In some embodiments, the time of the calcining of the heat treatment is in a range of 40 min-60 min. In some embodiments, the time of the calcining of the heat treatment is in a range of 50 min-60 min. In some embodiments, the time of the calcining of the heat treatment is 30 min, 40 min, 50 min, 60 min, etc.

The organosilica membrane prepared in the embodiments of the present disclosure has the porous intermediate layer. The porous intermediate layer refers to an intermediate layer having a porous structure.

In the embodiments of the present disclosure, the COOH-CNTs enable the SiO₂—ZrO₂ sol particles to be dispersed into a linear grid and the COOH-CNTs themselves have hydrophilicity and a pore channel structure, which allows a large number of water molecules to pass through the organosilica membrane quickly, reducing the permeation resistance of the water molecules in the intermediate layer and the separation layer. In pervaporation separation of water from a solvent aqueous solution, the organosilica membrane can exhibit good separation performance.

The present disclosure also provides the organosilica membrane with the porous intermediate layer prepared by the method. More descriptions regarding the method for preparing the organosilica membrane with the porous intermediate layer may be found in the relevant content described above in the present disclosure.

The present disclosure also provides a method for performing pervaporation using the organosilica membrane with the porous intermediate layer. The method includes placing the organosilica membrane with the porous intermediate layer into a membrane module and performing the pervaporation to separate a solvent or an aqueous solution.

The present disclosure also provides a use of the organosilica membrane with the porous intermediate layer in pervaporation. For example, the organosilica membrane with the porous intermediate layer is placed into the membrane module to perform the pervaporation to separate the solvent or the aqueous solution.

The present disclosure also provides a manner for dehydration of an acidic system by pervaporation. The manner includes performing pervaporation of an acetic acid aqueous solution with a mass fraction of 90 wt % using the organosilica membrane with the porous intermediate layer. A heating temperature of the acetic acid aqueous solution is 75° C., and a permeate side is evacuated (e.g., a pressure of the permeate side is less than 400 Pa).

In the embodiments of the present disclosure, the organosilica membrane with the porous intermediate layer is prepared by doping the COOH-CNTs into the SiO₂—ZrO₂ sol and coating the COOH-CNTs/SiO₂—ZrO₂ sol onto the tubular ceramic support by the spin coating. By doping the COOH-CNTs, the SiO₂—ZrO₂ sol particles are dispersed in a nanotube network, which reduces the density of the silica-zirconium network structure and the number of coating times. The organosilica membrane with the porous intermediate layer is applied to the dehydration of acetic acid/aqueous solution by pervaporation, which improves the water permeation flux and the separation factor. The dense SiO₂—ZrO₂ sol particles are dispersed by the COOH-CNTs. The COOH-CNTs have the pore channel structure, which can serve as an additional transport channel for water molecules. The contained carboxyl groups further serve as hydrophilic sites to enhance water adsorption. All of these improve the transport efficiency of the water molecules within the organosilica membrane, which is beneficial for increasing the water flux in the pervaporation of a solvent and water. By the spin coating, the defect issues caused by wipe-coating and dip-coating are reduced, and the separation performance of the organosilica membrane is increased.

### EXAMPLE 1 PREPARATION OF ORGANOSILICA MEMBRANE WITH POROUS INTERMEDIATE LAYER

(1) Single-walled carbon nanotubes were placed in a mixture of concentrated sulfuric acid (98%) and concentrated nitric acid (68%) (V_{H2SO4}/V_{HNO3}=3/1), stirred and refluxed at 100° C. for 4 h. After completion, the carbon nanotubes were alternately washed with deionized water and ethanol until the carbon nanotubes reached a neutral pH. Finally, the washed carbon nanotubes were placed in a vacuum drying oven at 80° C. and dried for 24 h to obtain COOH-CNTs.

(2) 3 mg of the COOH-CNTs and 5 g of 2 wt % SiO₂—ZrO₂ sol were taken, and deionized water was added to make a total system to be 20 g. After ultrasonication for 1 h, a uniformly dispersed COOH-CNTs/SiO₂—ZrO₂ sol was obtained. A mass ratio of the COOH-CNTs to SiO₂—ZrO₂ in the obtained sol was 3 wt %.

(3) A tubular ceramic support was fixed on an iron rod and rotated. The COOH-CNTs/SiO₂—ZrO₂ sol was placed below the tubular ceramic support. At a low rotation speed of 20 rpm, the COOH-CNTs/SiO₂—ZrO₂ sol was loaded onto the tubular ceramic support, and then the COOH-CNTs/SiO₂—ZrO₂ sol below the tubular ceramic support was removed. The rotation speed was increased to 1000 rpm and maintained for 60 s for spin drying. The tubular ceramic support was placed in an oven at 200° C. and preheated for 5 min, then placed in a tube furnace at 550° C. and heated for 20 min. The foregoing operations in (3) were repeated 6 times to obtain a ceramic support with a porous intermediate layer.

(4) 1 g of BTESE was added to 10 g of ethanol, then 10 g of water and 0.05 g of hydrochloric acid were added for catalysis to obtain a mixture. The mixture was stirred at room temperature for 2 h to obtain an organosilica sol. A separation layer was prepared by spin coating. The organosilica sol was coated onto the ceramic support with the porous intermediate layer at a low rotation speed of 20 rpm. The rotation speed was increased to 1000 rpm and maintained for 30 s. After coating, calcining was performed in an air atmosphere at 250° C. for 30 min to obtain an organosilica membrane.

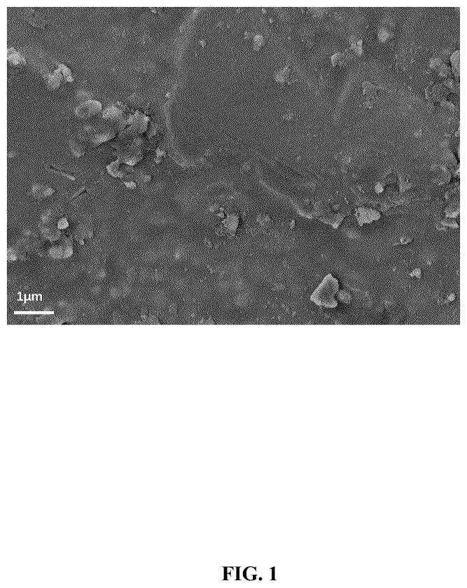

FIG. 1 is an SEM image of the organosilica membrane prepared in Example 1. As shown in FIG. 1, the surface of the organosilica membrane is continuous and has no obvious defects.

The organosilica membrane was used for a pervaporation test of an acetic acid aqueous solution with a mass fraction of 90 wt %. The acetic acid aqueous solution was heated to a temperature of 75° C., and a permeate side was evacuated (e.g., a pressure of the permeate side was less than 400 Pa). The obtained separation performance included a flux of 2.13 kg·m⁻²·h⁻¹ and a separation factor of 1312.

### EXAMPLE 2

The process for preparing an organosilica membrane was substantially the same as that in Example 1, except that in the COOH-CNTs/SiO₂—ZrO₂ sol, the amount of the SiO₂—ZrO₂ sol was kept unchanged, and a mass ratio of the COOH-CNTs to SiO₂—ZrO₂ was 1 wt %.

The organosilica membrane was used for a pervaporation test of an acetic acid aqueous solution with a mass fraction of 90 wt %. The acetic acid aqueous solution was heated to a temperature of 75° C., and a permeate side was evacuated (e.g., a pressure of the permeate side was less than 400 Pa). The obtained separation performance included a flux of 1.94 kg·m⁻²·h⁻¹ and a separation factor of 1033.

### EXAMPLE 3

The process for preparing an organosilica membrane was substantially the same as that in Example 1, except that in the COOH-CNTs/SiO₂—ZrO₂ sol, the amount of the SiO₂—ZrO₂ sol was kept unchanged, and a mass ratio of the COOH-CNTs to SiO₂—ZrO₂ was 5 wt %.

The organosilica membrane was used for a pervaporation test of an acetic acid aqueous solution with a mass fraction of 90 wt %. The acetic acid aqueous solution was heated to a temperature of 75° C., and a permeate side was evacuated (e.g., a pressure of the permeate side was less than 400 Pa). The obtained separation performance included a flux of 2.33 kg·m⁻²·h⁻¹ and a separation factor of 596.

### EXAMPLE 4

The process for preparing an organosilica membrane was substantially the same as that in Example 1, except that in the COOH-CNTs/SiO₂—ZrO₂ sol, the amount of the SiO₂—ZrO₂ sol was kept unchanged, and a mass ratio of the COOH-CNTs to SiO₂—ZrO₂ was 7 wt %.

The organosilica membrane was used for a pervaporation test of an acetic acid aqueous solution with a mass fraction of 90 wt %. The acetic acid aqueous solution was heated to a temperature of 75° C., and a permeate side was evacuated (e.g., a pressure of the permeate side was less than 400 Pa). The obtained separation performance included a flux of 2.45 kg·m⁻²·h⁻¹ and a separation factor of 312.

Examples 1-4 indicate that as the doping amount of the COOH-CNTs increases, the membrane flux increases accordingly, and the separation factor first increases and then decreases. The reason for the decrease of the separation factor is that when the doping amount of the COOH-CNTs reaches a certain level, the COOH-CNTs agglomerate, resulting in increased interface defects in the intermediate layer, thereby reducing the separation factor.

### COMPARATIVE EXAMPLE 1

A tubular ceramic support was fixed on an iron rod. The SiO₂—ZrO₂ sol was placed below the tubular ceramic support. The SiO₂—ZrO₂ sol was loaded onto the tubular ceramic support at a low rotation speed of 20 rpm. The rotation speed was then increased to 1000 rpm and maintained for 60 s for spin drying. Finally, the tubular ceramic support was placed in an oven at 200° C. and preheated for 5 min, then placed in a tube furnace at 550° C. and heated for 20 min. The foregoing operations were repeated 6 times to obtain a tubular ceramic support with an intermediate layer.

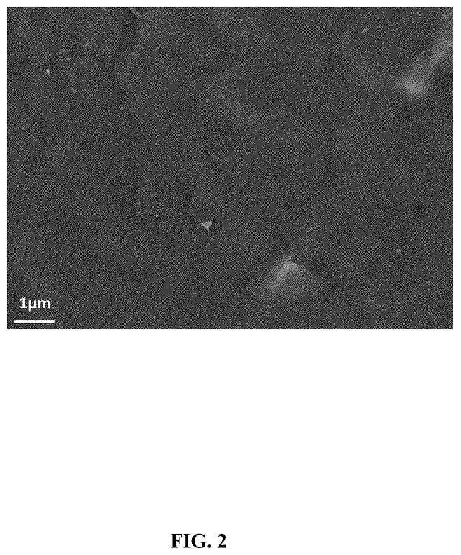

A BTESE separation layer was prepared by spin coating. The organosilica sol prepared in Example 1 was coated onto the tubular ceramic support with the intermediate layer at a low rotation speed of 20 rpm. The rotation speed was increased to 1000 rpm and maintained for 30 s. After coating, calcining was performed in an air atmosphere at 250° C. for 30 min to obtain an organosilica membrane. FIG. 2 is an SEM image of the organosilica membrane prepared in Comparative Example 1. As shown in FIG. 2, the surface of the organosilica membrane (also referred to as a BTESE membrane) is smooth and continuous.

The organosilica membrane was used for a pervaporation test of an acetic acid aqueous solution with a mass fraction of 90 wt %. The acetic acid aqueous solution was heated to a temperature of 75° C., and a permeate side was evacuated (e.g., a pressure of the permeate side was less than 400 Pa). The obtained separation performance included a flux of 1.31 kg·m⁻²·h⁻¹ and a separation factor of 1429.

### COMPARATIVE EXAMPLE 2

An intermediate layer was prepared by wipe-coating. A SiO₂—ZrO₂ sol was wipe-coated onto a tubular ceramic support. After coating, calcining was performed at 550° C. for 20 min. The coating and the calcining were repeated 6 times to complete the coating of the intermediate layer.

A separation layer was prepared by the wipe-coating. The organosilica sol prepared in Example 1 was wipe-coated onto the tubular ceramic support with the intermediate layer. Then, calcining was performed at 250° C. for 30 min to obtain an organosilica membrane.

The organosilica membrane was used for a pervaporation test of an acetic acid aqueous solution with a mass fraction of 90 wt %. The acetic acid aqueous solution was heated to a temperature of 75° C., and a permeate side was evacuated (e.g., a pressure of the permeate side was less than 400 Pa). The obtained separation performance included a flux of 1.53 kg·m⁻²·h⁻¹ and a separation factor of 977.

### COMPARATIVE EXAMPLE 3

An intermediate layer was prepared by wipe-coating. A SiO₂—ZrO₂ sol was wipe-coated onto a tubular ceramic support. After coating, calcining was performed at 550° C. for 20 min. The coating and the calcining were repeated 10 times to complete the coating of the intermediate layer.

A separation layer was prepared by the wipe-coating. The organosilica sol prepared in Example 1 was wipe-coated onto the tubular ceramic support with the intermediate layer. Then, calcining was performed at 250° C. for 30 min to obtain an organosilica membrane.

The organosilica membrane was used for a pervaporation test of an acetic acid aqueous solution with a mass fraction of 90 wt %. The acetic acid aqueous solution was heated to a temperature of 75° C., and the permeate side was evacuated (e.g., a pressure of the permeate side was less than 400 Pa). The obtained separation performance included a flux of 1.23 kg·m⁻²·h⁻¹ and a separation factor of 1450.

Comparing Comparative Example 1 with Examples 1-4, it indicates that the organosilica membrane with the intermediate layer doped with the COOH-CNTs has a higher flux.

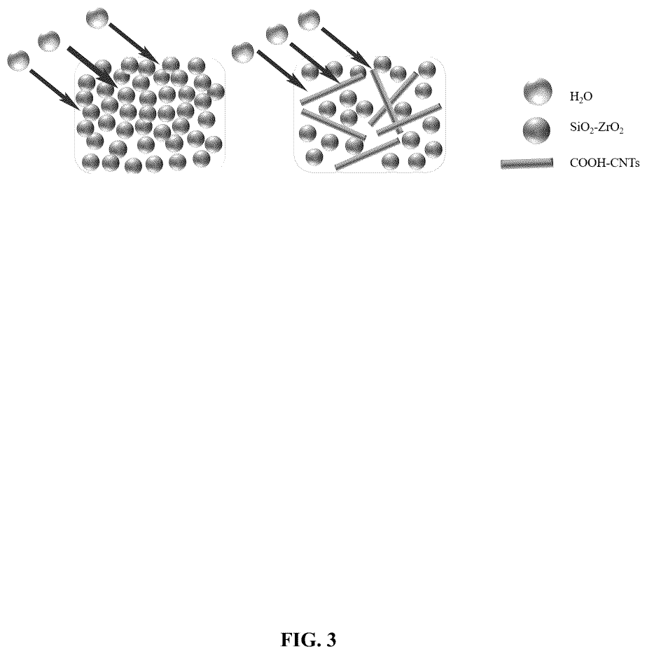

FIG. 3 is a schematic diagram of water molecules passing through an intermediate layer of the organosilica membrane. As shown in FIG. 3, for an intermediate layer not doped with the COOH-CNTs, the water molecules can only pass through gaps between the SiO₂—ZrO₂ sol particles. For the intermediate layer doped with the COOH-CNTs, the water molecules can also be rapidly transported through channels inside the COOH-CNTs. Comparing Comparative Examples 2-3 with Comparative Example 1, it indicates that the membrane prepared by the spin coating has comparable performance to the membrane prepared by the wipe-coating, but the spin coating requires fewer coating times.

As described above, although the present disclosure has been shown and described with reference to specific preferred embodiments, it should not be construed as limiting the present disclosure itself. Various changes may be made in form and detail without departing from the spirit and scope of the present disclosure as defined by the appended claims.

What is claimed is:

1. A method for preparing an organosilica membrane with a porous intermediate layer, comprising the following steps:
(1) treating carbon nanotubes with an acid, washing, and drying to obtain carboxylated carbon nanotubes (COOH-CNTs);
(2) adding water to the COOH-CNTs obtained in step (1) and a SiO₂—ZrO₂ sol, and mixing uniformly to obtain a COOH-CNTs/SiO₂—ZrO₂ sol;
(3) coating the COOH-CNTs/SiO₂—ZrO₂ sol obtained in step (2) onto a tubular ceramic support, and calcining to obtain a ceramic support with a porous intermediate layer; and
(4) coating an organosilica sol onto the ceramic support with the porous intermediate layer obtained in step (3), and performing heat treatment to form a separation layer, thereby obtaining the organosilica membrane;
wherein the organosilica sol is prepared by a hydrolytic polymerization reaction of an organosilica precursor selected from 1,2-bis(triethoxysilyl)ethane or bis(triethoxysilyl)methane.

2. The method according to claim 1, wherein, in step (1), the acid is a mixture of concentrated sulfuric acid and concentrated nitric acid, wherein a volume ratio of the concentrated sulfuric acid to the concentrated nitric acid is 3:1; a temperature of the treating is in a range of 60° C.-100° C., and a time of the treating is in a range of 2 h-4 h.

3. The method according to claim 1, wherein, in step (2), a mass ratio of the COOH-CNTs to SiO₂—ZrO₂ is in a range of 1%-7%.

4. The method according to claim 1, wherein, in step (3), the coating is spin coating, wherein the spin coating includes fixing the tubular ceramic support on an iron rod and rotating the tubular ceramic support, placing the COOH-CNTs/SiO₂—ZrO₂ sol below the tubular ceramic support, loading the COOH-CNTs/SiO₂—ZrO₂ sol onto the tubular ceramic support at a low speed, and performing spin drying of the COOH-CNTs/SiO₂—ZrO₂ sol at a high speed;
wherein the low speed has a rotation speed of 10 rpm-100 rpm, and
the high speed has a rotation speed of 600 rpm-6000 rpm, maintained for 30 s-60 s.

5. The method according to claim 1, wherein, in step (3), preheating is performed before the calcining, wherein a temperature of the preheating is in a range of 100° C.-200° C., and a time of the preheating is in a range of 5 min-10 min.

6. The method according to claim 1, wherein, in step (3), a temperature of the calcining is in a range of 450° C.-550° C., a time of the calcining is in a range of 20 min-60 min, and a count of repetitions of the coating and the calcining is in a range of 2-6 times.

7. The method according to claim 1, wherein, in step (4), the organosilica sol is prepared by a hydrolytic polymerization reaction of the organosilica precursor catalyzed by an acidic catalyst.

8. The method according to claim 1, wherein, in step (4), the heat treatment is calcining in an air atmosphere at a temperature in a range of 100° C.-250° C. for a time in a range of 30 min-60 min.

9. The organosilica membrane with the porous intermediate layer prepared by the method according to claim 1.

10. A use of the organosilica membrane with the porous intermediate layer according to claim 9 in performing pervaporation, comprising:
placing the organosilica membrane with the porous intermediate layer according to claim 9 into a membrane module, and performing the pervaporation to separate a solvent or an aqueous solution.
